(19) United States
(12) Patent Application Publication
(10) Pub. No.: US 2011/0314505 A1
(43) Pub. Date: Dec. 22, 2011

(54) SERVER FOR PROVIDING SHARED VOD BROADCASTING SERVICE IN MOBILE NETWORK, RECEPTION TERMINAL, BASE STATION, AND METHOD THEREOF

(75) Inventors: Jai Hyung Cho, Daejeon (KR); Sang Ho Lee, Daejeon (KR); Dong Jin Shin, Daejeon (KR)

(73) Assignee: ELECTRONICS AND TELECOMMUNICATIONS RESEARCH INSTITUTE, Daejeon (KR)

(21) Appl. No.: 13/145,708

(22) PCT Filed: Jan. 21, 2010
(86) PCT No.: PCT/KR2010/000397

§ 371 Date: Jul. 21, 2011

(30) Foreign Application Priority Data
Jan. 21, 2009 (KR) 10-2009-0004907
Dec. 1, 2009 (KR) 10-2009-0117611

(51) Int. Cl. H04N 7/173; H04N 7/16

(52) U.S. Cl. 725/62; 725/93

(57) ABSTRACT

The present invention relates to a method and apparatus of providing a shared Video on Demand (VoD) broadcasting service using a mobile communication network. The method and apparatus may concurrently provide, to a plurality of terminals requesting a first content, requested content from among broadcasting requested contents selected from a broadcasting content list, thereby effectively using radio resources.

### TECHNICAL FIELD

The present invention relates to an apparatus and method which may effectively utilize radio resources by concurrently providing, to a plurality of users, a content having a greatest number of requests of the users.

### BACKGROUND ART

To be provided with content download services such as Video on Demand (VoD) in a mobile communication network, a user may connect with a VoD content server using a mobile terminal to retrieve a content list, and select a desired content to download, to the mobile terminal, a file of the desired content.

In this case, since the content download services using the mobile communication network are provided while occupying a part of radio resource of a local cell where a user is located, the content download services may cause high data use fees, and may not be simultaneously provided to users exceeding a fixed number due to a limitation in the radio resource of the mobile network.

As for a mobile television, since contents to be broadcasted using the mobile television are previously determined by service providers, it may be difficult to select desired broadcasting contents of users, and thereby only passive viewing may be permitted for the user.

Accordingly, there is a need for an apparatus and method that may select the desired broadcasting contents, and effectively utilize radio resources required for transmitting contents.

### DISCLOSURE OF INVENTION

Technical Goals

An aspect of the present invention provides an apparatus and method of providing services that may broadcast a content stream to concurrent viewers for each content to enable a plurality of users to commonly receive contents, thereby effectively using radio resources.

Technical Solutions

According to an aspect of the present invention, there is provided a server of providing shared Video on Demand (VoD) broadcasting services, the server including: a content designation unit to designate a first priority requested content based on information received from a plurality of terminals; an available resource determining unit to determine an available resource with respect to respective cells including the terminal requesting the first priority requested content; and a stream transmission unit to assign, to the respective cells, resources used for transmitting the first priority requested content, and to transmit a stream with respect to the first priority requested content, when all of the respective cells have the available resource for providing the first priority requested content.

In this instance, when a cell without the available resource for providing the first priority requested content exists among the respective cells, the stream transmission unit may enter and remain in a wait state until the cell without the available resource obtains the available resource.

Also, the content designation unit may include: a broadcasting list providing unit to provide, to the plurality of terminals, a content list to be broadcasted; and a request list collecting unit to collect a requested content list from the plurality of terminals. In this instance, a requested content having a greatest number of requests from the collected requested content list may be designated as the first priority requested content.

Also, the available resource determining unit may include: a cell identification unit to identify the respective cells where the terminal requesting the first priority requested content exists; and a content providing-determination unit to determine whether the first priority requested content is provided based on information about a use of resource with respect to the respective cells.

Also, the information received from a plurality of terminals may include cell information where each of the plurality of terminals exists, and the cell identification unit may identify the respective cells based on the cell information.

Also, the cell identification unit may include a position retrieval unit to retrieve position information with respect to the plurality of terminals existing in a separate position information server based on the information received from the plurality of terminals, and identify a cell with respect to each of the plurality of terminals based on the position information retrieved in the position information server.

Also, the server further including an internal memory including at least one of a content ranking list, an amount of used resources for each cell, and a reception content list for each terminal.

Also, when the stream transmission unit transmits the stream for the first priority requested content, an internal memory may initialize a ranking of the first priority requested content stored in the content ranking list.

According to another aspect of the present invention, there is provided a terminal of receiving shared VoD broadcasting services, the terminal including: a broadcasting list receiving unit to receive a broadcasting content list from a broadcasting service providing server; a request list sending unit to send a requested content list selected from the broadcasting content list; and a content output unit to receive and output contents to be broadcasted.

In this instance, the request list sending unit may send the requested content list and terminal identification information.

According to still another aspect of the present invention, there is provided a base station of providing shared VoD broadcasting services, the base station including: a request list transmitting unit to transmit, to a broadcasting service providing server, a broadcasting requested content list received from a plurality of terminals; a broadcasting list transmitting unit to receive a broadcasting content list from the broadcasting service providing server, and to transmit the received broadcasting content list to the plurality of terminals; and a content transmission unit to transmit, to the plurality of terminals, contents received from broadcasting service providing server.

In this instance, the request list transmitting unit may transmit, to the broadcasting service providing server, the broadcasting requested content list and information about a cell including the plurality of terminals.

Also, the content transmission unit may include a resource assignment unit to allocate a bandwidth for transmitting contents, and a stream transmission unit to transmit a content stream using the allocated bandwidth.

According to further aspect of the present invention, there is provided a method of providing shared VoD broadcasting services, the method including: providing, to a plurality of terminals, a content list to be broadcasted, and collecting, from the plurality of terminals, terminal information including a requested content list; designating a first priority requested content by ranking the collected requested content list; determining an available resource with respect to respective cells including the terminal requesting the first priority requested content; and assigning, to the respective cells, the available resource for transmitting the first priority requested content when all of the respective cells have the available resource for providing the first priority requested content, and transmitting a stream with respect to the first priority requested content.

### ADVANTAGEOUS EFFECTS

According to exemplary embodiments, broadcasting services that broadcast a content stream to concurrent viewers for each content may be provided to enable a plurality of users to commonly receive contents, thereby effectively using radio resources.

### BRIEF DESCRIPTION OF DRAWINGS

FIG. 1 is a conceptual diagram illustrating a system of providing a shared Video on Demand (VoD) broadcasting service according to exemplary embodiments;

FIG. 2 is a block diagram illustrating a server of providing a shared VoD broadcasting service according to exemplary embodiments;

FIG. 3 is a block diagram illustrating a terminal of receiving a shared VoD broadcasting service according to exemplary embodiments;

FIG. 4 is a block diagram illustrating a base station of providing a shared VoD broadcasting service according to exemplary embodiments;

FIG. 5 is a flowchart illustrating a method of providing a shared VoD broadcasting service according to exemplary embodiments; and

FIG. 6 is a flowchart illustrating a method of receiving a shared VoD broadcasting service according to exemplary embodiments.

### BEST MODE FOR CARRYING OUT THE INVENTION

Reference will now be made in detail to embodiments of the present invention, examples of which are illustrated in the accompanying drawings, wherein like reference numerals refer to the like elements throughout. The embodiments are described below in order to explain the present invention by referring to the figures.

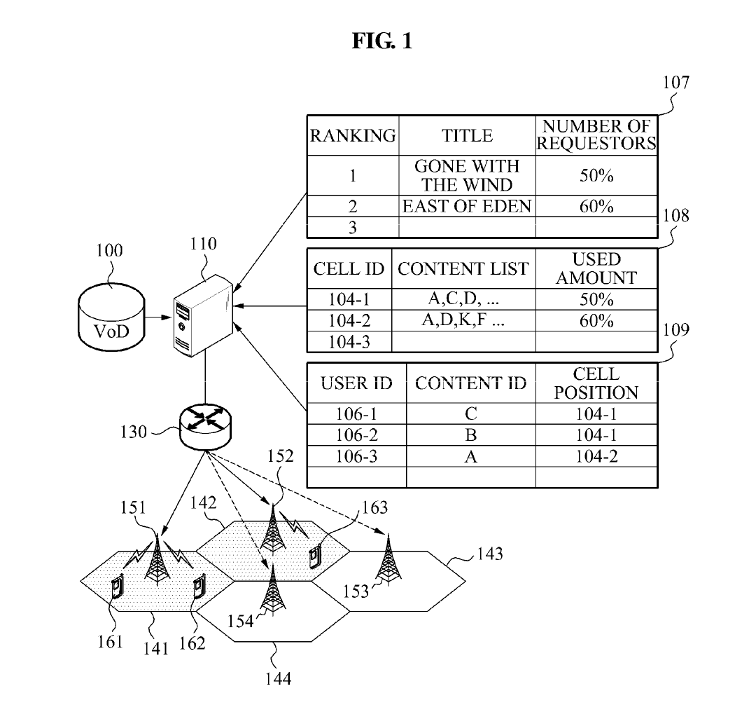

FIG. 1 is a conceptual diagram illustrating a system of providing a shared Video on Demand (VoD) broadcasting service according to exemplary embodiments.

Referring to FIG. 1, the system of providing the shared VoD broadcasting service may include a plurality of base stations 151, 152, 153, and 154, a plurality of mobile terminals 161, 162, and 163, an access node 130, a server of providing broadcasting services 110, and a VoD server 100.

The server 110 may be provided with a content list from the VoD server 100, and transmit the provided content list to the plurality of mobile terminals 161, 162, and 163 through the plurality of base stations 151, 152, 153, and 154. Also, the server 110 may receive a content broadcasting request message from the plurality of mobile terminals 161, 162, and 163, and estimate the received content broadcasting request message to generate a content list 107. Here, the content list 107 may be arranged for each ranking depending on a number of requests of users, and the server 110 may designate a first priority requested content having a greatest number of requests of users.

Also, the server 110 may extract cell information about cells including the plurality of mobile terminals 161, 162, and 163 which request the first priority requested content. Here, the cell information may be included in messages transmitted by the plurality of mobile terminals 161, 162, and 163. In this instance, the cell information may be directly extracted from the messages. Also, to extract the cell information, the server 110 may extract identification information of the plurality of mobile terminals 161, 162, and 163, which is included in the messages transmitted by the plurality of mobile terminals 161, 162, and 163, retrieve a separate terminal position information server using the identification information, and indirectly obtain the cell information of the mobile terminal from the retrieved server.

Here, the server 110 may retrieve information 108 about an amount of a used resource for each cell using the obtained cell information, and verify whether the cells have extra resources (available resource) used for broadcasting a new content stream. When it is verified there is a lack of the available resource, the server 110 may enter and remain in a wait state until all of the cells obtain sufficient available resources. Also, when all of the cells obtain the sufficient available resources, the server 110 may allocate resources for broadcasting the first priority requested content to start radio broadcasting services. Also, the server 110 may transmit, to the plurality of mobile terminals 161, 162, and 163, a list obtained by excluding the first priority requested content list from the content list, and thereby the procedure of designating the first priority content and of broadcasting the content stream may be repeated.

Also, the server 110 may maintain, in an internal memory, at least one of the content list 107, the information 108 about the amount of the used resource for each cell, and a reception content list 109 for each terminal.

The plurality of mobile terminals 161, 162, and 163 may receive a broadcasting content list from the base station, show the received broadcasting content list to users, and transmit the content broadcasting request message when a user selects a specific content. In this instance, the plurality of terminals 161, 162, and 163 may add the identification information of the terminal to the content broadcasting request message to thereby transmit the content broadcasting request message. Also, when the requested content stream is broadcasted, the plurality of mobile terminals 161, 162, and 163 may receive the broadcasted content stream to show the received content stream to users.

The plurality of base stations 151, 152, 153, and 154 may wirelessly transmit, to the plurality of mobile terminals 161, 162, and 163, the content list transmitted by the server 110. Also, the plurality of base stations 151, 152, 153, and 154 may transmit, to the server 110, the content broadcasting request message transmitted by the plurality of mobile terminals 161, 162, and 163. In this instance, the plurality of base stations 151, 152, 153, and 154 may add, to the received content broadcasting request message, the cell information about cells 141, 142, 143, and 144 including the plurality of base stations 151, 152, 153, and 154. Also, the plurality of base stations 151, 152, 153, and 154 may allocate radio resources used for broadcasting the content stream, and broadcast, to the plurality of mobile terminals 161, 162, and 163, the content stream transmitted by the server 110.

The access node 130 may relay data transmitted to the plurality of base stations 151, 152, 153, and 154 by the server 110, or may relay data transmitted to the server 110 by the plurality of base stations 151, 152, 153, and 154.

The VoD server 100 may transmit the content list 107 to be broadcasted to the server 110, and provide the content stream requested by the server 110.

As described above, the content having a greatest number of requests of users may be concurrently transmitted to a plurality of users, thereby effectively utilizing radio resources.

Hereinafter, detailed configurations and functions of the server 110, the plurality of base stations 151, 152, 153, and 154, and the plurality of mobile terminals 161, 162, and 163 will be further described.

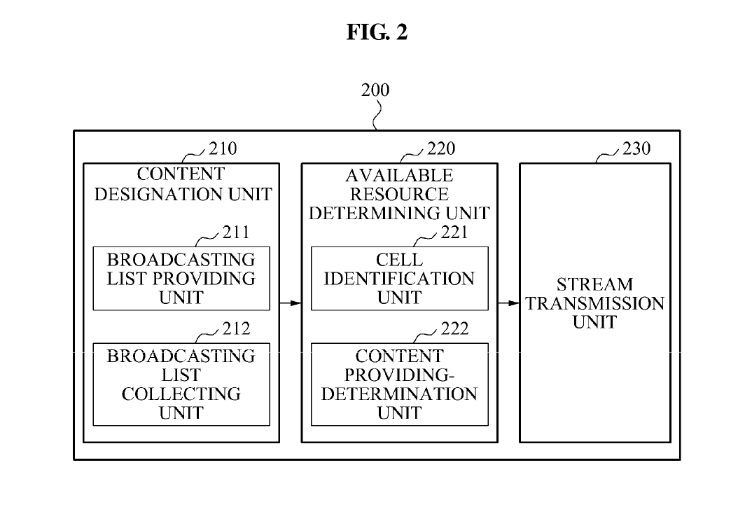

FIG. 2 is a block diagram illustrating a server 200 of providing a shared VoD broadcasting service according to exemplary embodiments.

Referring to FIG. 2, the server 200 includes a content designation unit 210, an available resource determining unit 220, and a stream transmission unit 230.

The content designation unit 210 may designate a first priority requested content based on information received from the plurality of terminals. That is, the content designation unit 210 may collect a broadcasting requested content list from the plurality of terminals, estimate the collected broadcasting requested content list for each ranking based on a number of requests of users, and designate the first priority requested content from the estimated broadcasting requested content list. Here, to rank the broadcasting requested content list, other weights, which would be obvious to those skilled in the art, may be also adopted as well as the number of requests of users.

The available resource determining unit 220 may determine an available resource for each cell including a terminal requesting the first priority requested content. Here, the available resource determining unit 220 may extract cell information for determining the available resource for each cell. In this instance, the cell information may be extracted using either cell information provided by the base station or a separate position information server. For example, when the base station transmits the broadcasting requested content list, the cell information may be transmitted together with the broadcasting requested content list. In this case, using the cell information provided by the base station, the available resource for each cell may be determined. Also, using the separate position information server, positions of terminals requesting the first priority requested content may be determined, and the available resources for the cell including the terminals may be determined.

When all of respective cells have the available resource for providing the first priority requested content, the stream transmission unit 230 may allocate, to the respective cells, the available resource for transmitting the first priority requested content to thereby transmit a stream with respect to the first priority requested content. Here, when a cell without the available resource for providing the first priority requested content exists, the stream transmission unit 230 may enter and remain in a wait state until the cell without the available resource obtains the available resource.

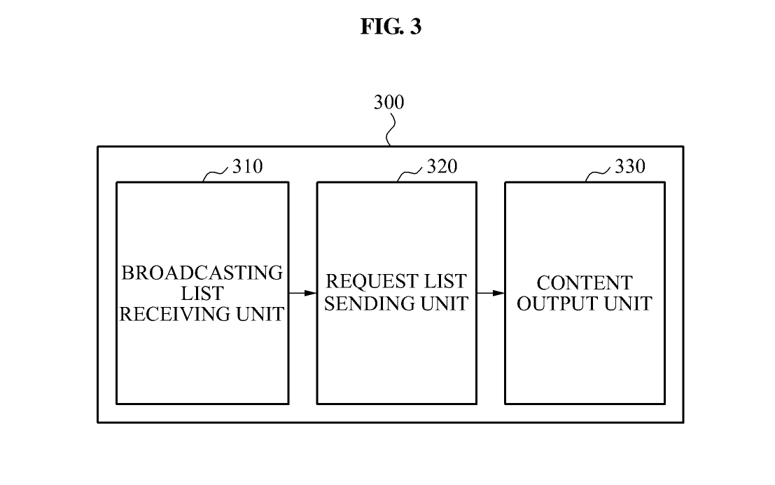

FIG. 3 is a block diagram illustrating a terminal 300 of receiving a shared VoD broadcasting service according to exemplary embodiments.

Referring to FIG. 3, the terminal 300 includes a broadcasting list receiving unit 310, a request list sensing unit 320, and a content output unit 330.

The broadcasting list receiving unit 310 may receive a broadcasting content list from a broadcasting service providing server. That is, the broadcasting list receiving unit 310 may receive the broadcasting content list provided by the broadcasting service providing server, and determine a content that is to be currently broadcasted.

The request list sending unit 320 may send a requested content list selected from the broadcasting content list. That is, the request list sending unit 320 may select a desired content from the received broadcasting content list, and send the requested content list to the broadcasting service providing server. In this instance, the request list sending unit 320 may send the requested content list and terminal identification information.

The content output unit 330 may receive and output contents to be broadcasted. That is, when the broadcasting service providing server broadcasts the requested contents, the content output unit 330 may receive and output the broadcasted requested contents.

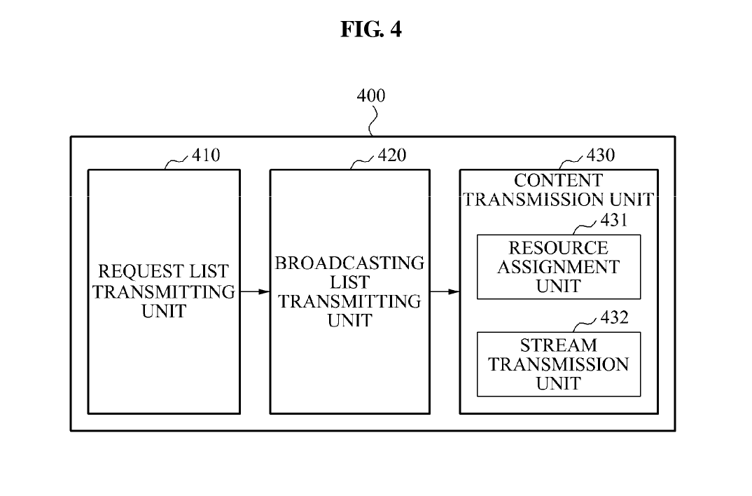

FIG. 4 is a block diagram illustrating a base station 400 of providing a shared VoD broadcasting service according to exemplary embodiments.

Referring to FIG. 4, the base station 400 includes a request list transmitting unit 410, a broadcasting list transmitting unit 420, and a content transmission unit 430.

The request list transmitting unit 410 may transmit, to a broadcasting service providing server, a broadcasting requested content list received from a plurality of terminals. That is, the request list transmitting unit 410 may receive the broadcasting requested content list from the plurality of terminals, and transmit, to the broadcasting service providing server, the received broadcasting requested content list. In this instance, the request list transmitting unit 410 may transmit, to the broadcasting service providing server, the broadcasting requested content list and information about a cell including the plurality of terminals.

The broadcasting list transmitting unit 420 may receive a broadcasting content list from the broadcasting service providing server, and transmit the received broadcasting content list to the plurality of terminals. That is, the broadcasting list transmitting unit 420 may receive, from the broadcasting service providing server, the broadcasting content list that is to be currently broadcasted, and transmit, to the plurality of terminals, the received broadcasting content list.

The content transmission unit 430 may transmit, to the plurality of terminals, contents received from broadcasting service providing server. That is, when the broadcasting contents requested by the plurality of terminals are transmitted by the broadcasting service providing server, the content transmission unit 430 may receive the broadcasting contents, and broadcast the received broadcasting contents to the plurality of terminals.

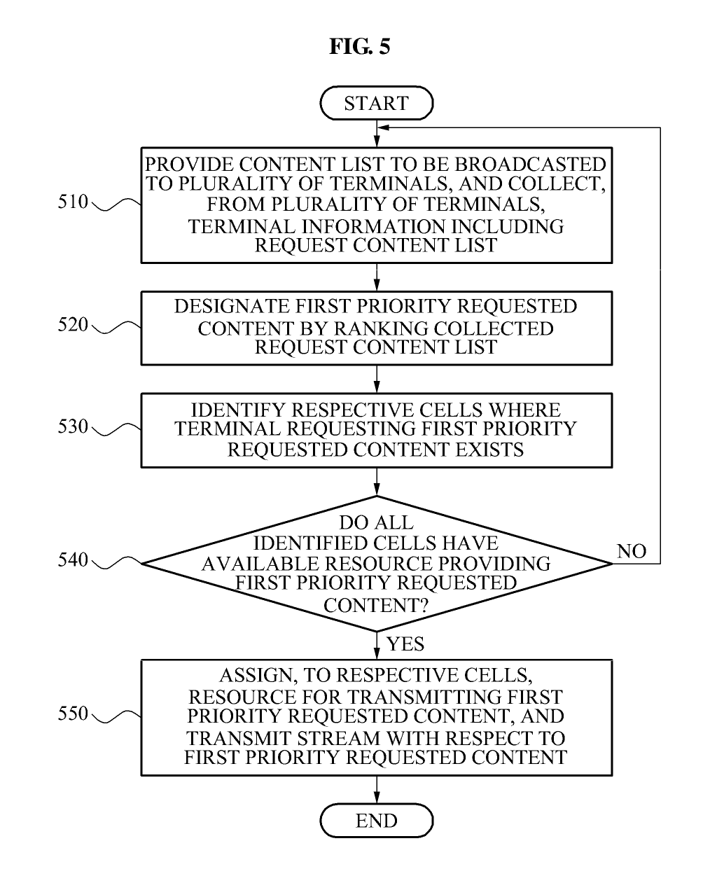

FIG. 5 is a flowchart illustrating a method of providing a shared VoD broadcasting service according to exemplary embodiments.

In operation 510, the method may provide, to a plurality of terminals, a content list that is to be broadcasted, and collect, from the plurality of terminals, terminal information including a requested content list. Here, the terminal information may include cell information where each of the plurality of terminals exists. In operation 520, the method may designate a first priority requested content by ranking the collected requested content list. Here, in operation 520, a requested content having a greatest number of requests of users from the collected requested content list may be designated as the first priority requested content.

In operation 530, the method may identify respective cells including a terminal requesting the first priority requested content. Here, operation 530 may include retrieving position information with respect to the plurality of terminals existing in a separate position information server based on the information received from the plurality of terminals, and identifying a cell with respect to each of the plurality of terminals based on the position information retrieved in the position information server.

In operation 540, the method may determine whether all of the identified cells have an available resource that enables the first priority requested content to be provided. Here, whether all of the identified cells have the available resource may be determined using the cell information received from the base stations. Also, whether all of the identified cells have the available resource may be determined such that positions of terminals are determined using the separate position information server, and the available resource with respect to the cell including each of the plurality of terminals may be determined.

In operation 550, when all of the identified cells have the available resource, the method may allocate, to the respective cells, a resource for transmitting the first priority requested content to thereby transmit a stream with respect to the first priority requested content. In this instance, in operation 550, the method may initialize a ranking of the first priority requested content stored in the content ranking list.

Also, when a cell without the available resource for providing the first priority requested content exists among the respective cells, the method may enter and remain in a wait state until the cell without the available resource obtains the available resource.

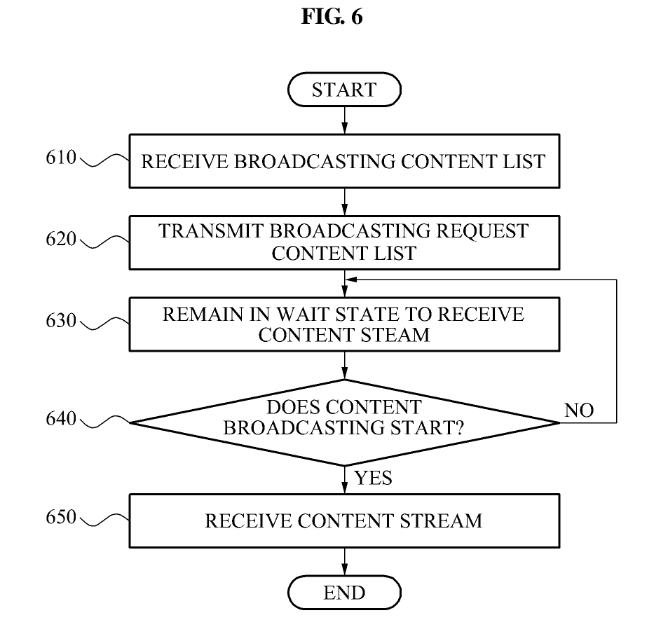

FIG. 6 is a flowchart illustrating a method of receiving a shared VoD broadcasting service according to exemplary embodiments.

In operation 610, the method may receive, from a broadcasting service providing server via a base station, a content list. Here, the content list may indicate a list of contents that is to be broadcasted by the broadcasting service providing server.

In operation 620, the mobile terminal may select a specific content from the received content list, and transmit, to the broadcasting service providing server, a request content list for requesting broadcasting content. In this instance, the request content list may be transmitted to the broadcasting service providing server via the base station.

In operation 630, the method may enter and remain in a wait state until receiving a stream with respect to the content requested by the mobile terminal.

In operation 640, the method may determine whether a broadcasting with respect to the requested content starts. In operation 650, when the broadcasting starts, the method may receive a corresponding content stream.

As described above, according to exemplary embodiments, contents requested by the plurality of terminals may be ranked depending on a number of requests of users, and a content having a greatest number of requests may be concurrently provided.

Accordingly, a plurality of users may commonly receive the requested contents, and thereby radio resources may be effectively shared.

Although a few embodiments of the present invention have been shown and described, the present invention is not limited to the described embodiments. Instead, it would be appreciated by those skilled in the art that changes may be made to these embodiments without departing from the principles and spirit of the invention, the scope of which is defined by the claims and their equivalents.

1. A server of providing shared Video on Demand (VoD) broadcasting services, the server comprising:
a content designation unit to designate a first priority requested content based on information received from a plurality of terminals;
an available resource determining unit to determine an available resource with respect to respective cells including the terminal requesting the first priority requested content; and
a stream transmission unit to assign, to the respective cells, resources used for transmitting the first priority requested content, and to transmit a stream with respect to the first priority requested content, when all of the respective cells have the available resource for providing the first priority requested content.

2. The server of claim 1, wherein, when a cell without the available resource for providing the first priority requested content exists among the respective cells, the stream transmission unit enters and remains in a wait state until the cell without the available resource obtains the available resource.

3. The server of claim 1, wherein the content designation unit comprises:
a broadcasting list providing unit to provide, to the plurality of terminals, a content list to be broadcasted; and
a request list collecting unit to collect a requested content list from the plurality of terminals, wherein
a requested content having a greatest number of requests from the collected requested content list is designated as the first priority requested content.

4. The server of claim 1, wherein the available resource determining unit comprises:
a cell identification unit to identify the respective cells where the terminal requesting the first priority requested content exists; and
a content providing-determination unit to determine whether the first priority requested content is provided based on information about a use of resource with respect to the respective cells.

5. The server of claim 4, wherein the information received from a plurality of terminals includes cell information where each of the plurality of terminals exists, and the cell identification unit identifies the respective cells based on the cell information.

6. The server of claim 4, wherein the cell identification unit comprises a position retrieval unit to retrieve position information with respect to the plurality of terminals existing in a separate position information server based on the information received from the plurality of terminals, and identifies a cell with respect to each of the plurality of terminals based on the position information retrieved in the position information server.

7. The server of claim 1, further comprising:
an internal memory including at least one of a content ranking list, an amount of used resources for each cell, and a reception content list for each terminal.

8. The server of claim 7, wherein, when the stream transmission unit transmits the stream for the first priority requested content, the internal memory initializes a ranking of the first priority requested content stored in the content ranking list.

9. A terminal of receiving shared Video on Demand (VoD) broadcasting services, the terminal comprising:
a broadcasting list receiving unit to receive a broadcasting content list from a broadcasting service providing server;
a request list sending unit to send a requested content list selected from the broadcasting content list; and
a content output unit to receive and output contents to be broadcasted.

10. The terminal of claim 9, wherein the request list sending unit sends the requested content list and terminal identification information.

11. A base station of providing shared Video on Demand (VoD) broadcasting services, the base station comprising:
a request list transmitting unit to transmit, to a broadcasting service providing server, a broadcasting requested content list received from a plurality of terminals;
a broadcasting list transmitting unit to receive a broadcasting content list from the broadcasting service providing server, and to transmit the received broadcasting content list to the plurality of terminals; and
a content transmission unit to transmit, to the plurality of terminals, contents received from broadcasting service providing server.

12. The base station of claim 11, wherein the request list transmitting unit transmits, to the broadcasting service providing server, the broadcasting requested content list and information about a cell including the plurality of terminals.

13. The base station of claim 11, wherein the content transmission unit comprises:
a resource assignment unit to allocate a bandwidth for transmitting contents; and
a stream transmission unit to transmit a content stream using the allocated bandwidth, wherein
the resource assignment unit enters and remains in a wait state until an available bandwidth for transmitting the contents is obtained, when the available bandwidth is unavailable.

14. A method of providing shared Video on Demand (VoD) broadcasting services, the method comprising:
providing, to a plurality of terminals, a content list to be broadcasted, and collecting, from the plurality of terminals, terminal information including a requested content list;
designating a first priority requested content by ranking the collected requested content list;
determining an available resource with respect to respective cells including the terminal requesting the first priority requested content; and
assigning, to the respective cells, a resource for transmitting the first priority requested content when all of the respective cells have the available resource for providing the first priority requested content, and transmitting a stream with respect to the first priority requested content.

15. The method of claim 14, further comprising:
remaining in a wait state until a cell without the available resource for providing the first priority requested content obtains the available resource, when the cell without the available resource exists.

16. The method of claim 14, wherein the designating designates, as the first priority requested content, a requested content having a greatest number of requests from the collected requested content list.

17. The method of claim 14, wherein the determining comprises:
identifying the respective cells where the terminal requesting the first priority requested content exists; and
determining whether the first priority requested content is provided based on information about a use of resource with respect to the respective cells.

18. The method of claim 17, wherein the terminal information includes cell information where each of the plurality of terminals exists, and the identifying identifies the respective cells based on the cell information.

19. The method of claim 17, wherein the identifying comprises:
retrieving position information with respect to the plurality of terminals existing in a separate position information server based on the information received from the plurality of terminals; and
identifying a cell with respect to each of the plurality of terminals based on the position information retrieved in the position information server.

20. The method of claim 14, wherein the transmitting of the stream comprises initializing a ranking of the first priority requested content stored in the content ranking list.
